(19) United States
(12) Patent Application Publication
(10) Pub. No.: US 2026/0104509 A1
(43) Pub. Date: Apr. 16, 2026

(54) IMAGE SENSING DEVICE

(71) Applicant: SK hynix Inc., Gyeonggi-do (KR)

(72) Inventors: Toshiaki NAGAI, Tokyo (JP); Yusuke YATA, Tokyo (JP)

(21) Appl. No.: 19/203,174

(22) Filed: May 9, 2025

(30) Foreign Application Priority Data
Oct. 15, 2024 (KR) 10-2024-0140231

(51) Int. Cl. G01S 17/14; G01S 7/4865

(52) U.S. Cl. CPC G01S 17/14; G01S 7/4865

(57) ABSTRACT

An image sensing device capable of detecting a distance to a target object according to a time-of-flight (TOF) method is disclosed. The image sensing device includes a pixel configured to generate a pulse signal based on a photon reflected from a target object; a plurality of time-to-digital converters (TDCs) configured to generate digital codes corresponding to a time delay between the pulse signal and a reference pulse; and a histogramming circuit configured to generate index information of a memory region and an update value of the memory region based on the digital codes, wherein the plurality of TDCs have different activation timing points.

### CROSS-REFERENCE TO RELATED APPLICATION

This patent application claims the priority and benefits of Korean patent application No. 10-2024-0140231, filed on Oct. 15, 2024, which is incorporated herein by reference in its entirety.

### TECHNICAL FIELD

Embodiments of the present disclosure generally relate to an image sensing device.

### BACKGROUND

Recently, Time of Flight (TOF) technology, which has been in the spotlight, emits pulse-shaped light from a light source located within or near a sensor to a target object, receives light reflected from the target object, calculates a round trip time using emitted light and reflected light, and measures the distance to the target object using the calculated round trip time according to the principle of constancy of light velocity. To precisely measure the TOF, since a reaction must occur as soon as light reaches a light receiving element, photoelectric conversion elements with very high sensitivity are required for TOF technology. To this end, research on single-photon avalanche diodes (SPADs) which can be manufactured by CMOS fabrication technology has been actively conducted.

Lidar sensors can detect a target object located around a user and can recognize a distance between the target object and the user, so that the Lidar sensors can prevent accidents that the user has not recognized in advance and enable autonomous driving of various electronic devices. TOF technology can be used to identify the distance to the target object using Lidar sensors.

### SUMMARY

Various embodiments of the present disclosure provide a TOF-based image sensing device capable of reducing a memory capacity while improving an operating speed thereof.

In accordance with an embodiment of the present disclosure, an image sensing device may include a pixel configured to generate a pulse signal based on a photon reflected from a target object; a plurality of time-to-digital converters (TDCs) configured to generate digital codes corresponding to a time delay between the pulse signal and a reference pulse; and a histogramming circuit configured to generate index information of a memory region and an update value of the memory region based on the digital codes, wherein the plurality of TDCs have different activation timing points.

In accordance with an embodiment of the present disclosure, an image sensing device may include a pixel configured to generate a pulse signal based on a photon reflected from a target object; a time-to-digital converter (TDC) block configured to generate digital codes corresponding to a time delay between the pulse signal and a reference pulse; and a histogramming circuit configured to generate a first feature function and a second feature function, each of which has a waveform corresponding to an order of a spline function within a time stamp section in which the photon responds, and generate information of a memory region and an update value of the memory region based the first feature function and the second feature function, wherein each of the first feature function and the second feature function is discretized with respect to a time stamp value and a number of detection counts of the photon, and has a step shape in which each step has a different peak value.

In accordance with an embodiment of the present disclosure, a method of operating an image sensing device may include generating a pulse signal based on a photon reflected from a target object; generating, at different timing points, digital codes corresponding to a time delay between the pulse signal and a reference pulse; and generating index information of a memory region and an update value of the memory region based on the digital codes.

It is to be understood that both the foregoing general description and the following detailed description of the embodiments of the present disclosure are illustrative and descriptive and are intended to provide further description of the embodiments as claimed.

### BRIEF DESCRIPTION OF THE DRAWINGS

The above and other features and beneficial aspects of the embodiments of the present disclosure will become readily apparent with reference to the following detailed description when considered in conjunction with the accompanying drawings.

FIG. 1 is a diagram illustrating a Lidar system according to an embodiment of the present disclosure.

FIG. 2 is a diagram illustrating operations of the image sensing device shown in FIG. 2, according to an embodiment of the present disclosure.

FIG. 3 is a diagram illustrating a histogram according to a photon counting value for use in a histogramming circuit shown in FIG. 1, according to an embodiment of the present disclosure.

FIG. 4 is a diagram illustrating feature functions for use in the image sensing device shown in FIG. 1, according to an embodiment of the present disclosure.

FIGS. 5A and 5B are diagrams illustrating histogramming operations for use in the image sensing device shown in FIG. 1, according to an embodiment of the present disclosure.

FIG. 6 is a diagram illustrating another image sensing device, according to an embodiment of the present disclosure.

FIGS. 7 to 10 are diagrams illustrating histogramming operations for use in the image sensing device shown in FIG. 6, according to an embodiment of the present disclosure.

FIG. 11 is a diagram illustrating yet another image sensing device, according to an embodiment of the present disclosure.

FIGS. 12 to 15 are diagrams illustrating histogramming operations for use in the image sensing device shown in FIG. 11, according to an embodiment of the present disclosure.

FIG. 16 is a schematic diagram illustrating still another image sensing device according to still an embodiment of the present disclosure.

FIGS. 17 and 18 are diagrams illustrating histogramming operations for use in the image sensing device shown in FIG. 16, according to an embodiment of the present disclosure.

FIG. 19 is a timing diagram illustrating operations of a control signal generator shown in FIG. 6.

FIG. 20 is a block diagram illustrating an imaging device including an image sensing device according to the embodiments of the present disclosure.

### DETAILED DESCRIPTION

This present disclosure provides embodiments and examples of an image sensing device capable of detecting a distance to a target object according to a time-of-flight (TOF) method that may be used in configurations to substantially address one or more technical or engineering issues and to mitigate limitations or disadvantages encountered in some image sensing devices in the art. Some embodiments of the present disclosure relate to a TOF based image sensing device capable of reducing a memory capacity while improving an operating speed thereof. In recognition of the issues above, the image sensing device based on TOF technology according to the present disclosure can reduce a memory capacity required for system operations while improving an operating speed thereof.

Reference will now be made in detail to some embodiments of the present disclosure, examples of which are illustrated in the accompanying drawings. Wherever possible, the same reference numbers will be used throughout the drawings to refer to the same or like parts. While this disclosure is susceptible to various modifications and alternative forms, specific embodiments thereof are shown by way of example in the drawings. However, this disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of advantageous effects capable of being directly or indirectly recognized.

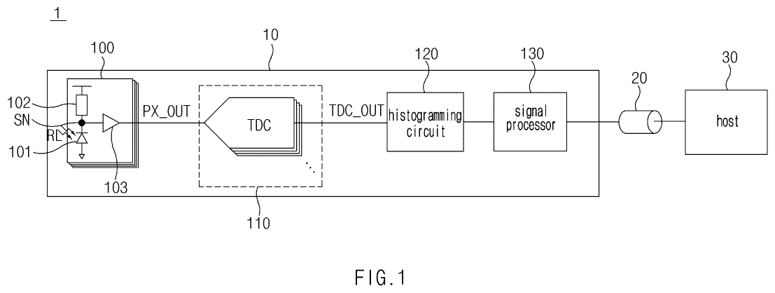

FIG. 1 is a circuit diagram illustrating a Lidar system 1 according to an embodiment of the present disclosure.

Referring to FIG. 1, the Lidar system 1 may include an image sensing device 10, a communication interface 20, and a host 30.

The image sensing device 10 may include a pixel 100, a time-to-digital converter (hereinafter referred to as “TDC”) block 110, a histogramming circuit 120, and a signal processor 130. For example, the image sensing device 10 may measure a time until light is reflected from a target object and returns by using a time-correlated single-photon counting (hereinafter referred to as “TCSPC”) method.

The pixel 100 includes a single-photon avalanche diode (SPAD) element (hereinafter referred to as a “SPAD” element) 101, a quenching circuit 102, and a buffer 103. The pixel 100 may be grouped into a macropixel unit including at least one SPAD element 101. The pixel 100 may include one macropixel, or may include a plurality of macropixels arranged in an array form.

The SPAD element 101 may detect a single photon of reflected light (RL) reflected from a target object, and may generate a voltage pulse corresponding to the detected single photon. The SPAD element 101 may operate as a photodiode including a photosensitive P-N junction. Since avalanche breakdown is triggered by a single photon incident in a Geiger mode in which a reverse bias voltage caused by a cathode-anode voltage higher than a breakdown voltage occurs, the SPAD element 101 may generate a voltage pulse. The Geiger mode may mean applying a reverse bias voltage greater than the breakdown voltage to the SPAD element 101 in order to detect a single photon in the SPAD element 101. In the Geiger mode, since the intensity of an electric field applied to an amplifying layer is large, even if a small number of photons is absorbed, an avalanche current breakdown phenomenon occurs and a large amount of current is output, such that a single photon can be detected. In this way, the process in which avalanche breakdown is triggered by a single photon and a voltage pulse is generated will hereinafter be defined as an avalanche process.

The SPAD element 101 may be connected to a ground voltage terminal through one terminal (i.e., an anode) thereof. The other terminal (i.e., a cathode) of the SPAD element 101 may be connected to a sensing node (SN). The SPAD element 101 may generate a current pulse by detecting a single photon and may output the generated current pulse to the sensing node (SN).

Although an embodiment of the present disclosure has disclosed that the SPAD element 101 is illustrated as a light receiving element (i.e., a light detection element) of the pixel 100, the scope of the embodiment is not limited to the SPAD element 101. That is, as a light receiving element of the pixel 110, in addition to the SPAD element 101, various elements operating in the Geiger mode, such as an avalanche photodiode (APD), a silicon photomultiplier (SiPM), and the like, can be used.

The quenching circuit 102 may control the voltage of the SPAD element 101 and may output the resultant voltage to the sensing node (SN). After a voltage pulse is generated due to avalanche breakdown and the voltage of the sensing node (SN) changes, the quenching circuit 102 may perform a quenching operation for returning the voltage of the sensing node (SN) to the Geiger mode.

The quenching circuit 102 may be connected between the sensing node (SN) and the ground voltage terminal. For example, if the quenching circuit 102 is implemented as an active device, this quenching circuit 102 may be implemented as a transistor. In another embodiment, if the quenching circuit 102 is implemented as a passive device, the quenching circuit 102 may be implemented as a resistor.

The buffer 103 may generate a pulse signal based on an electrical signal generated according to photons incident upon the pixel 100, and may output a pixel signal (PX_OUT). The buffer 103 may generate a pulse signal at a frequency according to a frequency of receiving photons. The buffer 103 may sample an analog voltage pulse generated from a sensing node (SN), and may convert the sampled analog voltage pulse into a digital pulse signal (i.e., a SPAD pulse). The sampling method may be a method of converting a voltage pulse into a pulse signal having a logic level of 0 or 1 depending on whether a level of the voltage pulse is equal to or higher than a threshold level, but the embodiments of the present disclosure are not limited thereto.

The TDC block 110 may calculate a time delay between the pixel signal (PX_OUT) output from the pixel 100 and a reference pulse of emitted light (EL), and may convert the time delay into a digital value, and may generate TDC data (TDC_OUT). The pulse signal of the pixel signal (PX_OUT) generated from the pixel 100 may be referred to as a SPAD pulse. In some embodiments, the TDC block 110 may include a plurality of TDCs.

The histogramming circuit 120 may generate a histogram based on the TDC data (TDC_OUT). The histogramming circuit 120 may accumulate and store time stamp data in timebins based on the TDC data (TDC_OUT), and may determine a bin having a peak value. In some embodiments, the histogramming circuit 120 may also be included in the pixel 100. The detailed operations of the histogramming circuit 120 will be described in more detail with reference to the following embodiments to be described below.

The signal processor 130 may determine a distance to the target object by calculating the time of flight (TOF) of light (hereinafter referred to as “light TOF”) based on histogram data received from the histogramming circuit 120. The signal processor 130 may be implemented as, for example, a general purpose digital signal processor, a processor, or a controller including a combination circuit connected to a memory. In addition, the signal processor 130 may also be implemented as a custom application-specific integrated circuit (ASIC), and the type of the signal processor is not limited thereto.

Data on the light TOF calculated by the signal processor 130 may be transmitted to the host 30 through the communication interface 20. For example, the communication interface 20 may be a serial communication interface. For example, the host 30 may provide a three-dimensional (3D) distance image of the target object through some interfaces such as a display screen or a user interface (UI) based on data received through the communication interface 20.

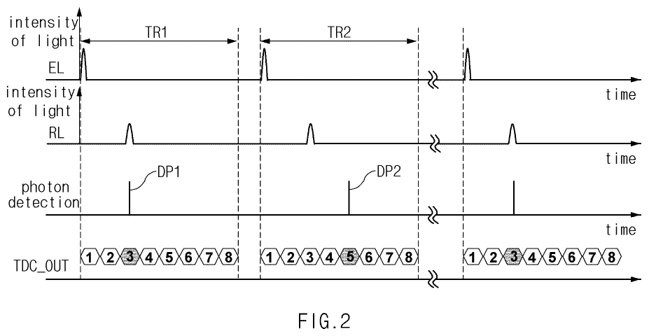

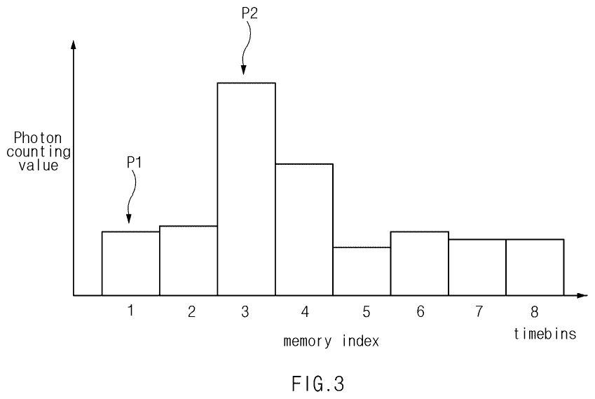

FIG. 2 is a diagram illustrating operations of the image sensing device 10 shown in FIG. 2 according to an embodiment of the present disclosure. FIG. 3 is a diagram illustrating a histogram according to a photon counting value for use in the histogramming circuit 120 shown in FIG. 1.

Referring to FIG. 2, the image sensing device 10 may emit pulse-shaped light (i.e., emitted light EL) from a light source, may receive light (i.e., reflected light RL) reflected from the target object, may calculate a round trip time using emitted light (EL) and reflected light (RL), and may measure the distance to the target object using the calculated round trip time according to the principle of constancy of light velocity.

The emitted light (EL) may be projected onto the target object in the form of dots through the image sensing device 10. Depending on the distance to the target object, the position of the projected dot may change or the intensity of the emitted light (EL) may become stronger or weaker. In some embodiments, the image sensing device 10 may operate in a photon counting mode for finding the position of the dot at the beginning of the operation thereof.

The SPAD element 101 may detect a single photon of reflected light (RL) reflected by the target object, and may generate a SPAD pulse (DP) corresponding to the detected single photon. The TDC block 110 may measure the time from a start time at which light emission begins in synchronization with the emitted light (EL) to a response time at which any SPAD 101 included in the pixel 100 responds to the emitted light (EL). A measurement range (TR1) for detecting photons may be divided into a finite number of timebins. In some embodiments, the measurement range (TR1) may be divided into 8 timebins.

Referring to FIG. 3, a horizontal axis of the histogram may represent timebins that may respectively represent sub-ranges of the photon arrival times. For example, the histogramming circuit 120 may include the same number of memory regions as the number of timebins, and each of the memory regions may maintain an independent value. Accordingly, each index value of the memory region may correspond to a discretized observation time.

For example, the number of the memory regions of the histogramming circuit 120 may be set to 8. The memory regions of the histogramming circuit 120 may be represented by memory indexes 1 to 8 corresponding to codes of the TDC data (TDC_OUT) (hereinafter referred to as “TDC codes” or “digital codes”).

A vertical axis of the histogram may represent a photon counting value. A counter value in the initial timebin is relatively low, and may correspond to background noise (P1). A reflected pulse (P2) having a peak value at the time points of some timebins may be detected.

The histogramming circuit 120 may accumulate and store photon counting values in a plurality of timebins. The histogramming circuit 120 may acquire distance information based on a timebin (e.g., memory index “3”) having the largest hit count value among the plurality of timebins.

The SPAD pulse (DP1) may respond at a time corresponding to the TDC code “3” in the measurement range (TR1) where the first emitted light (EL) is emitted. In this case, the value stored in the memory region “3” may be incremented by “+1”. Then, the SPAD pulse (DP2) may respond at a time corresponding to the TDC code “5” in the measurement range (TR2) where the second emitted light (EL) is emitted. In this case, the value stored in the memory region “5” may be incremented by “+1”. In this way, the operations of transmitting the emitted light (EL), detecting the SPAD pulse corresponding to the reflected light (RL), and updating the histogram are repeatedly performed, resulting in formation of the histogram as shown in FIG. 3.

In the histogram shown in FIG. 3, it can be seen that the photon counting value stored in the memory region “3” represents the largest value and has a larger value than a non-adjacent memory region (e.g., memory region “7”). As a result, the signal processor 130 may determine that the image sensing device 10 is receiving the reflected light (RL) from a desired target object within a time domain corresponding to the memory region “3”.

In the embodiments of FIGS. 2 and 3, the SPAD element 101 may not respond at a time at which the photon caused by the reflected light (RL) is received. Alternatively, there are some cases where the SPAD element 101 responds at a time other than the time at which the photon caused by the reflected light (RL) is received. For example, it can be seen that the SPAD pulse does not respond at the TDC code “3” corresponding to the reflected light (RL) in the measurement range (TR2), and the SPAD pulse (DP2) responds at the TDC code “5” in the measurement range (TR2).

That is, it cannot be limited that photons due to reflected light (RL) are incident upon the SPAD element 101 in the measurement range (TR2). In addition, even though photons are incident upon the SPAD element 101, the probability (i.e., photon detection efficiency, PDE) that the SPAD element 101 will respond may not be 100%. That is, in a situation where measurement processing is not performed in a dark place, if there is a photon having a sensitive wavelength, noise from a light source (e.g., ambient light) other than the emitted light (EL) may exist. In addition, even if no photons are incident upon the SPAD element 101, a response (e.g., dark count) due to noise may occur with a certain probability.

As a result, it may be difficult to measure the desired time with only one response. Therefore, measurement of the time at which the emitted light (EL) is transmitted and the response of the SPAD pulse is detected may be performed repeatedly, and a difference between a time range (that has a high frequency with respect to the light transmitting time) and the light transmitting time may be measured as a round trip time (RTT) of light.

The image sensing device 10 may require a considerable amount of memory capacity to store the histogram for each pixel 100. Therefore, a partial histogramming method or a sketched LiDAR method may be used to reduce the memory capacity.

According to the partial histogramming method, the histogram is not generated at once, but is divisionally generated in stages by performing measurement several times. The partial histogram method may create a coarse histogram by observing the entire measurement range at rough time intervals, may detect a peak indicating a maximum value of the coarse histogram, may zoom in on the detected peak, and may thus create a fine histogram with a fine time window.

However, according to the partial histogram method, the frame rate may deteriorate because the number of measurements increases. In addition, since the range observed by fine measurement must be wider than the time range corresponding to 2 bins of coarse measurement, a time resolution may be sacrificed (reduced). Also, as the number of measurements increases, the effect of reducing memory capacity may be deteriorated.

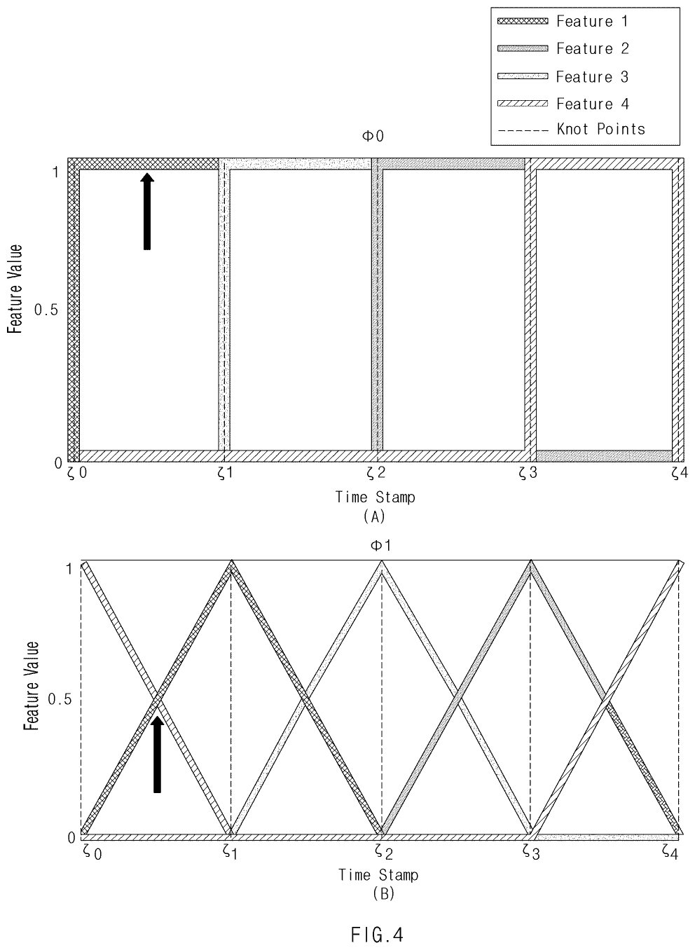

On the other hand, the sketched LiDAR method may not count the values of the bin corresponding to the time at which photons are detected one by one, may calculate a feature function that has a finer time change than a time interval of the bins, and may then store and accumulate the calculated value in the memory. Various functions may be applied to the feature function, but a spline function can be used. This feature function will be described in more detail with reference to FIG. 4 to be described below.

FIG. 4 is a diagram illustrating feature functions for use in the image sensing device 10 shown in FIG. 1.

In FIG. 4, the SPAD element 101 responds to photons N times. In this case, each response time (i.e., a time stamp) may be defined as “xⱼ (where j=1, 2, . . . n)”. Each memory region of the histogramming circuit 120 may maintain a value (Z_{p,i}) of a spline sketch defined by the following equations 1 and 2.

$${z}_{p , i} = \frac{1}{n} {\sum }_{j = 1}^{n} {Φ}_{p , i} ( {x}_{j} ) \qquad Equation 1$$

In Equation 1, φ_{p,i}(xⱼ) may be defined as a feature function (referred to as “FF” in the drawings to be described below).

Equation 1 may mean that, whenever a time stamp is obtained, a discrete Fourier Transform is performed to calculate the feature function, and the calculated value is kept in the memory region.

$${Φ}_{p , i} ( x ) = {ϕ}_{p} ( \frac{( x \text{} mod \text{} Δ )}{Δ} − i ) \qquad Equation 2$$

In Equation 2, Δ is the entire measurement time divided by M, where M is the number of sketches to be obtained. Here, ‘i’ is denoted by ‘i=1, . . . , M’, and may correspond to the observed statistical value (i.e., the number of sketches). The number (M) of sketches may correspond to the number of memory regions, and may have the same meaning as the number of bins for use in the TCSPC method. ‘p’ is the order of the spline function. ‘φₚ’ is a spline function of the order (p). In this way, the “feature function” may represent a function that sketches a sine-shaped waveform corresponding to the order of the spline function within the time stamp interval in which a photon response occurs N times.

For example, in the case where the order of the spline function is 0, the spline function can be defined as Equation 3, and in the case where the order of the spline function is 1, the spline function can be defined as Equation 4.

$${ϕ}_{0} ( x ) = \{ \begin{matrix}1 & x ∈ [ 0 , 1 ) \\ 0 & otherwise\end{matrix} . \qquad Equation 3$$

$${ϕ}_{1} ( x ) = \{ \begin{matrix}x & x ∈ [ 0 , 1 ) \\ 2 − x & x ∈ [ 1 , 2 ) \\ 0 & otherwise\end{matrix} \qquad Equation 4$$

In FIG. 4, (A) may represent a feature function when the order (p) of the spline function is set to zero ‘0’. (A) may denote an example case where the number (M) of sketches (i.e., the number of memory regions) is set to “4”, and four memory regions corresponding to the first to fourth features (feature1˜feature4) may store the corresponding accumulated values. For example, photons are detected in a time range of time stamps (ξ0, ξ1). Then, when the SPAD element 101 responds as illustrated in the arrow direction shown in (A) of FIG. 4, the value stored in the memory region “1” may be increased by “+1”. Therefore, when the order (p) of the spline function is “0”, the histogramming operation can be performed in the same manner as in the TCSPC operation described in FIG. 1.

In FIG. 4, (B) may represent a feature function when the order (p) of the spline function is set to “1”. Unlike the case where the order (p) of the spline function is set to “0”, the feature value increased by one photon detection is not denoted by two values of {0, 1}.

Each memory region stores a value as a floating point. Then, for example, when a photon is detected at the arrow point shown in (B) of FIG. 4, according to the above-described equation 1, the value stored in memory region “1” and the feature value stored in the memory region “2” may reach “+0.5” at the same time.

In another example, the operation of maintaining the value stored in each memory region as a floating point may lead to an increase in a circuit scale from the perspective of circuit implementation, so that it may also be possible to maintain the value as an integer value. In this case, for example, the feature value of the vertical axis of (B) of FIG. 4 may be increased (for example, increase by 100 times), and a value after the decimal point can be rounded off to obtain an integer value. In this case, if the value to be multiplied by a value on the vertical axis is small, the measurement value has an error due to influence of the rounding error, so that it is needed to properly select the allowable error.

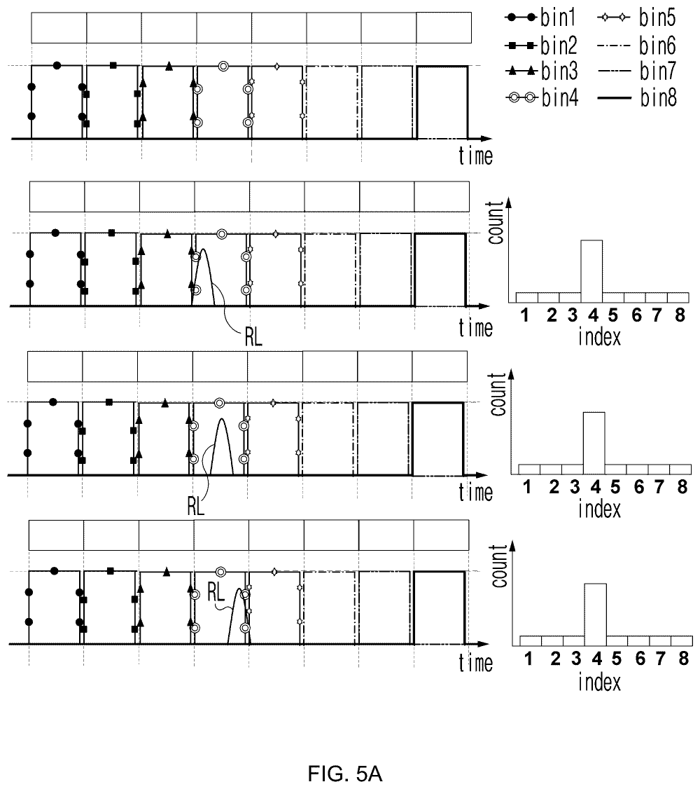

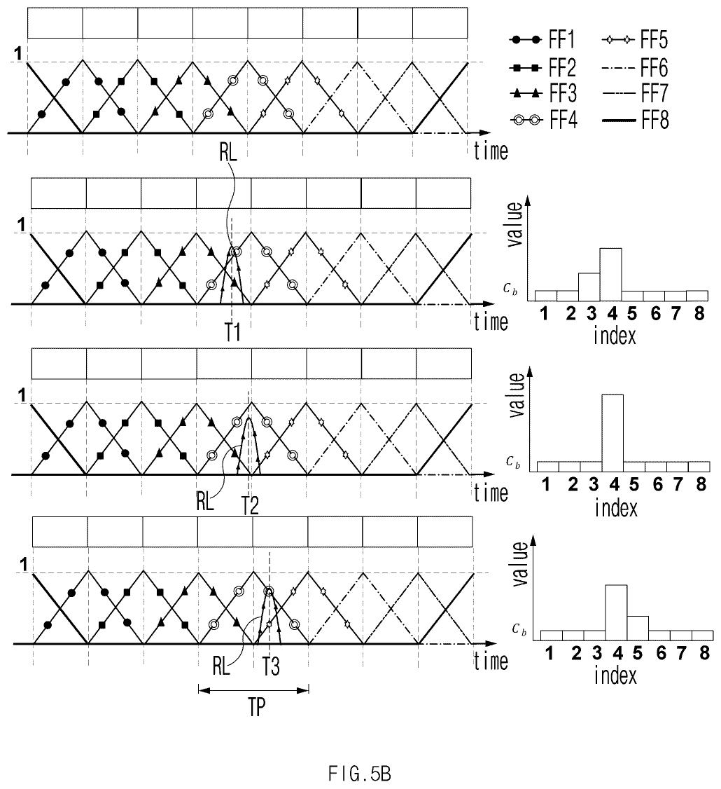

FIGS. 5A and 5B are diagrams illustrating histogramming operations for use in the image sensing device 10 shown in FIG. 1.

FIG. 5A shows an example of generating the histogram by the TCSPC method. For example, in the time domain corresponding to Bin 4 (bin4), the histogram may be generated in the same memory region regardless of the timing at which photon detection of reflected light (RL) occurs. Further, the influence of noise is not considered.

On the other hand, FIG. 5B shows an example of generating the histogram by the spline sketch method. For example, the photon detection of the reflected light (RL) occurs in the measurement period (TP). If photon detection of the reflected light (RL) occurs at the timing point (T1), all feature values of feature functions FF3 and FF4 may be generated.

Accordingly, the histogram may be changed not only in the value of the memory region “4” but also in the value of the memory region “3” adjacent to the memory region “4”. If photon detection of the reflected light (RL) occurs at the timing point (T2), the feature value of the feature function FF4 may be generated, and a change in the histogram of the memory region “4” may appear. If photon detection of the reflected light (RL) occurs at the timing point (T3), all feature values of the feature functions FF4 and FF5 can be generated. Accordingly, a change in the histogram may appear not only in the value of the memory region “4” but also in the value of the memory region “5” adjacent to the memory region “4”.

That is, the histogram may be changed depending on whether the time at which photon detection of the reflected light (RL) is performed in the measurement period (TP) is closer to the T1 timing point or the T3 timing point.

In this case, a center value of the histogram may be obtained for three values (C3, C4, C5) of the memory regions (3, 4, 5) after excluding the value (Cb) caused by the ambient light (or dark count). Accordingly, the position of a waveform of the reflected light (RL) may be obtained at a more detailed level than in the TCSPC method.

Specifically, the center value (Tc) of the histogram can be calculated as represented by Equation 5 below.

$${T}_{C} = \frac{3 Δ ( {C}_{3} − {C}_{b} ) + 4 Δ ( {C}_{4} − {C}_{b} ) + 5 Δ ( {C}_{5} − {C}_{b} )}{( {C}_{3} − {C}_{b} ) + ( {C}_{4} − {C}_{b} ) + ( {C}_{5} − {C}_{b} )} + offset \qquad Equation 5$$

If the center value (Tc) of the reflected light (RL) is obtained based on a timing point at which the emitted light (EL) is generated and the response characteristics of the SPAD pulse, the light TOF (time of flight) can be calculated. As shown in Equation 5, the center value (Tc) of the histogram may have a finer resolution than ‘A’ described in Equation 2.

That is, since the light TOF is calculated by the center value (Tc) calculated by Equation 5 and then added to and averaged with values of adjacent memory regions, the histogramming method of FIG. 5B may have a finer time resolution using the same number of memory regions as in the histogramming method of FIG. 5A. That is, when applying the method of FIG. 5B, the number of memory regions required to obtain the desired time resolution may be smaller than that of FIG. 5A.

However, the sketched LiDAR method needs to operate the TDC at high speed, thereby increasing power consumption. In addition, the memory capacity required per memory region may increase, so that the memory capacity corresponding to one memory region may increase. When precision of the histogram is greatly limited by short noise caused by photons of the ambient light, the effect of reducing the number of memory regions may also be limited. There is a limitation in reducing the number of memory regions when noise increases. To improve such phenomena, the image sensing devices to be described later can be implemented.

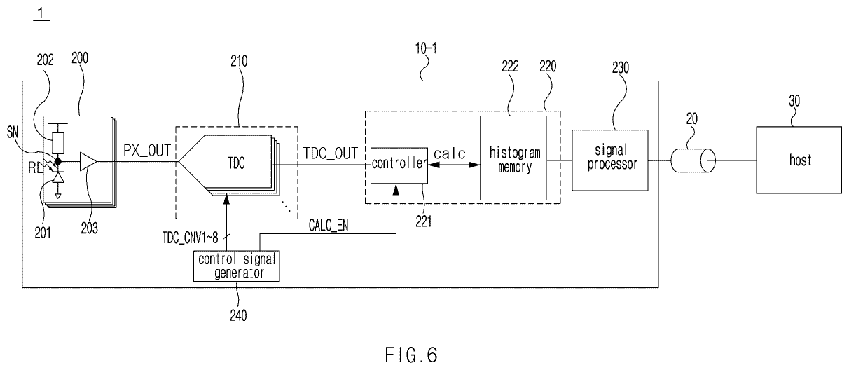

FIG. 6 is a schematic diagram illustrating an image sensing device 10_1 according to another embodiment of the present disclosure.

Referring to FIG. 6, the image sensing device 10_1 may include a pixel 200, a TDC block 210, a histogramming circuit 220, a signal processor 230, and a control signal generator 240. In the image sensing device 10_1, duplicate descriptions of the same components as those of FIG. 1 will herein be omitted for brevity, and only different components from those of FIG. 1 will be described in detail with reference to FIG. 6.

The pixel 200 may include a SPAD element 201, a quenching circuit 202, and a buffer 203. The SPAD element 201 may detect a single photon of reflected light (RL) reflected by a target object and may generate a voltage pulse corresponding to the detected single photon. The quenching circuit 202 may control the voltage of the SPAD element 201 and may output the resultant voltage to a sensing node (SN). The buffer 203 may generate a pulse signal based on an electrical signal generated according to photons incident upon the pixel 200, and may output a pixel signal (PX_OUT).

The TDC block 210 may calculate a time delay between a SPAD pulse output from the pixel 200 and a reference pulse of the emitted light (EL), and may generate a digital code representing the time delay, i.e., TDC data (TDC_OUT).

The TDC block 210 may obtain the timing point of generating the reference pulse of the emitted light (EL) from a timing controller (to be described later) controlling a light source driver, or may consider a predetermined time (e.g., a time prior to a certain time from the start time of a frame) as the timing point of generating the reference pulse. According to another embodiment, the TDC block 210 may also obtain the generation time of the reference pulse from the control signal generator 240. According to one embodiment, the TDC block 210 may be included in the pixel 200.

In the present disclosure, the TDC block 210 may include a plurality of TDCs. According to one embodiment, the number of the plurality of TDCs may correspond to the number of pixels 200, and the number of TDCs is not limited thereto. The operation timing points of the plurality of TDCs may be controlled differently according to the plurality of TDC control signals (TDC_CNV1˜TDC_CNV8) received from the control signal generator 240. For example, the plurality of TDCs may be sequentially activated based on the plurality of TDC control signals (TDC_CNV1˜TDC_CNV8) to generate a plurality of digital codes (TDC_OUT0˜TDC_OUT7). In another example, the operation timing points of the plurality of TDCs may be controlled differently according to the plurality of TDC control signals (TDC_CNV1˜TDC_CNV4).

For example, the plurality of TDCs may be sequentially activated based on the plurality of TDC control signals (TDC_CNV1˜TDC_CNV4) to generate a plurality of digital codes (TDC_OUT0˜TDC_OUT15). In the present disclosure, the number of TDC control signals and the number of digital codes are not limited thereto.

Each of the plurality of TDC control signals (TDC_CNV1˜TDC_CNV8) may have an activation level (e.g., a logic level of 1) when generation of TDC data (TDC_OUT) for the pixel 200 is required, and may have a deactivation level (e.g., a logic level of 0) when generation of TDC data (TDC_OUT) for the pixel 200 is not required. Detailed operations of the TDC block 210 will be described in more detail with reference to the attached drawings to be described below.

The histogramming circuit 220 may generate a histogram based on TDC data (TDC_OUT). The histogramming circuit 220 may include a controller 221 and a histogram memory 222.

The controller 221 may be activated based on an enable signal (CALC_EN) received from the control signal generator 240. For example, the controller 221 may perform the histogramming operation based on TDC data (TDC_OUT) when the enable signal (CALC_EN) is at an activation level (e.g., a logic level of 1). On the other hand, the controller 221 may stop the histogramming operation when the enable signal (CALC_EN) is at a deactivation level (e.g., a logic level of 0).

The controller 221 may perform the histogramming operation by overlapping the value of a timebin corresponding to the time of detecting the photon with the value of an adjacent timebin using a spline function having a fine temporal change. The controller 221 may discretize a sinusoidal feature function with respect to a time stamp value and the number of photon detection counts, may sequentially increase the feature function within a plurality of time sections and then decrease the feature function. In this way, the controller 221 may implement the sinusoidal feature function as a step-shaped function. According to an embodiment, the feature function may be implemented in a step shape that sequentially decreases and then increases within a plurality of time sections. The controller 221 may determine an update (weight) value of the timebin according to a specific shape along which a corresponding feature function in each measurement period overlaps the feature function of a neighbor measurement period adjacent to the measurement period.

The controller 221 may generate information about a memory region (e.g., memory index information) and an update value for the corresponding memory region based on the TDC data (TDC_OUT). For example, the controller 221 may determine a memory region to be updated in response to a TDC code and may generate an update value of the corresponding memory region as ‘+1’. The memory region information and the updated value (calc) generated by the controller 221 may be stored in the histogram memory 222.

The histogram memory 222 may update the value stored in the corresponding memory region by the update value (e.g., +1). According to an embodiment, the histogram memory 222 may include an integer counter. The histogram memory 222 may perform an update operation of the corresponding memory region by incrementing the integer counter once in response to the index information of the memory region and the update value ‘+1’. The values stored in the histogram memory 222 may be output to the signal processor 230 in certain units (e.g., frame units).

The control signal generator 240 may generate a plurality of TDC control signals (TDC_CNV1˜TDC_CNV8) for controlling the operation timing points of the plurality of TDCs. The plurality of TDC control signals (TDC_CNV1˜TDC_CNV8) may be activated at different timing points. For example, the plurality of TDC control signals (TDC_CNV1˜TDC_CNV8) may be activated sequentially. The control signal generator 240 may generate an enable signal (CALC_EN) for activating the controller 221. For example, the control signal generator 240 may activate the enable signal (CALC_EN) when the transfer signal (TX_ON to be described later) is activated at the time when the emitted light (EL) is irradiated.

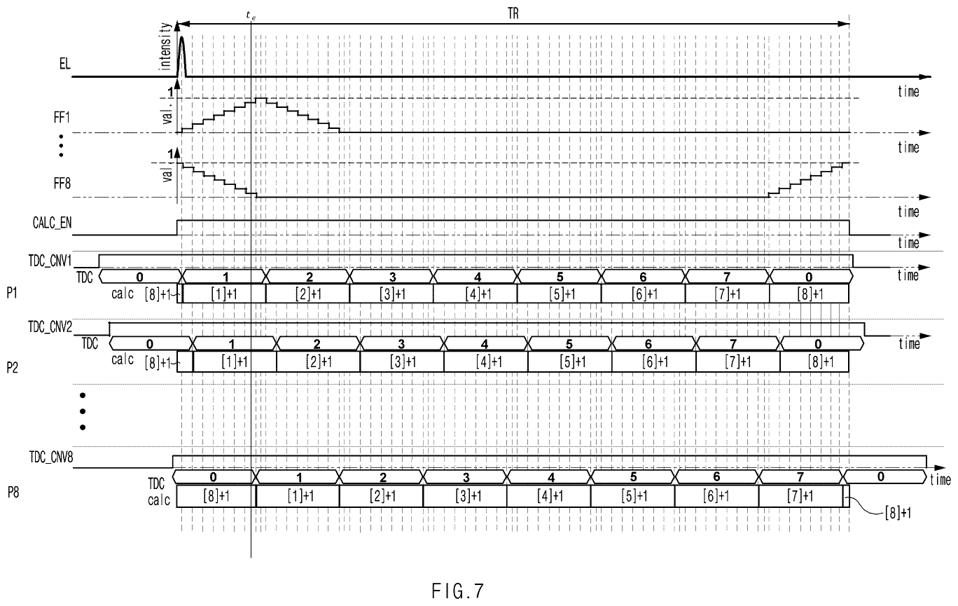

FIG. 7 is a diagram illustrating the histogramming operation for use in the image sensing device shown in FIG. 6.

The embodiment of FIG. 7 shows an example operation in which the histogramming circuit 220 performs the histogramming operation using the spline sketch method described in FIGS. 4 and 5B.

Referring to FIG. 7, the order (p) of the spline function is set to ‘1’ and the number (M) of memory regions is set to ‘8’. The feature function may be expressed as ‘FFi’, where ‘i’ may mean an index of the memory region. For example, the feature function (FF) may be set to 8 (FF1˜FF8), and each feature function may be set to a first-order spline function with a different peak value. The value (val) shown on the vertical axis may represent the feature value of the feature function (FF), and may be a value substituted into a discrete function of a step shape of 8 steps. For example, a time width corresponding to 1 step of the discrete function of this step shape may be set to be smaller than a pulse width of the emitted light (EL).

The controller 221 may be activated based on the enable signal (CALC_EN) during the measurement range (TR). That is, the enable signal (CALC_EN) may transition to a logic high level (e.g., a first level) at a timing point when the first emitted light (EL) occurs. When there is a response to a SPAD pulse, not only the TDC code but also a strobe signal indicating that and a response has occurred may be transmitted from the TDC block 210 to the controller 221. This strobe signal may be included in the TDC data (TDC_OUT).

The time resolution of TDC data (TDC_OUT) may be set to ⅛, not 1 stage of the discrete function. That is, 8 stages of each discrete function may correspond to one TDC code. The TDC block 210 may convert a response time of the SPAD pulse into one TDC code using a time resolution corresponding to 8 steps of each discrete function. The TDC block 210 may generate 8 TDC codes (0˜7) using a time resolution that divides the measurement time into 8 time sections.

In order to implement each feature function (FF), the control signal generator 240 according to the present disclosure may perform switching of 8 timing points (i.e., 8 phases) P1 to P8 for each emission of the emitted light (EL). For example, the timing point of P1 may be used during the first emission of the emitted light (EL), and the timing point of P2 may be used during the second emission of the emitted light (EL). In this way, the timing point of P8 may be used during the eighth emission of the emitted light (EL). In the ninth emission of the emitted light (EL), the timing point of P1 may be used again, and in the tenth emission of the emitted light (EL), the timing point of P2 may be used. In this way, the timing points of P1 to P8 may be used in a cyclical manner as described above.

First, at the P1 timing point, if the TDC control signal (TDC_CNV1) is at a logic high level (e.g., a first level) before the measurement range (TR) is started, the first TDC may be activated and transition of the TDC code may begin. For example, when there was a response to the SPAD pulse at the timing point (the), then, at the P1 timing point, the TDC code when the response to the SPAD pulse is detected may be ‘1’. In this case, the controller 221 may output the index ‘1’ of the memory region to be updated and the value ‘+1’ to be added. Then, the value stored in the memory region ‘1’ of the histogram memory 222 may be updated by ‘+1’.

Subsequently, at the P2 timing point, the TDC control signal (TDC_CNV2) may be initiated with a time delay of ⅛ of the time resolution of the TDC data (TDC_OUT). That is, the TDC control signal (TDC_CNV2) may be activated with a certain time delay compared to the TDC control signal (TDC_CNV1). When the TDC control signal (TDC_CNV2) reaches a logic high level (e.g., a first level), the second TDC may be activated and transition of the TDC code may begin.

For example, when there was a response to the SPAD pulse at the timing point (the), then, the TDC code when the response to the SPAD pulse is detected at the P2 timing point may be ‘1’. In this case, the controller 221 may output the index ‘1’ of the memory region to be updated and the value ‘+1’ to be added. As a result, the value stored in the memory region ‘1’ of the histogram memory 222 may be updated by ‘+1’. Similarly, the histogramming operation of the controller 221 as described above may be performed at each of the P3 to P7 timing points.

Thereafter, at the P8 timing point, the TDC control signal (TDC_CNV8) may be initiated with a time delay of ⅞ of the time resolution of the TDC data (TDC_OUT) compared to the P1 timing point. That is, the TDC control signal (TDC_CNV8) may be activated with a certain time delay compared to the TDC control signal (TDC_CNV7). When the TDC control signal (TDC_CNV8) reaches a logic high level (e.g., a first level), the eighth TDC may be activated and transition of the TDC code may begin.

For example, when there was a response to the SPAD pulse at the timing point (the), then, the TDC code when the response to the SPAD pulse is detected at the P8 timing point may be ‘0’. In this case, the controller 221 may output the index ‘8’ of the memory region to be updated and the value ‘+1’ to be added. As a result, the value stored in the memory region ‘8’ of the histogram memory 222 may be updated by ‘+1’.

The controller 221 may output “+1” as the update value of the memory region to be updated. Therefore, the controller 221 may not update the value of the histogram memory 222 even if it receives a strobe signal of the TDC code from the TDC block 210 in a time section where the enable signal (CALC_EN) is deactivated (i.e., a time section where the enable signal (CALC_EN) is at a logic low level (second level)).

The probability that the SPAD element 101 responds to the photon does not change at the timing points P1˜P8. Then, when the photon is incident upon the SPAD element 101 at the timing point (the), it can be seen that the value of the memory region 1 or the value of the memory region 8 is updated. It can be seen that the frequency at which the value of the memory region 1 is updated is 7:1 with respect to the frequency at which the value of the memory region 8 is updated.

As described above, the image sensing device 10_1 according to the present embodiment may not fix the operation timing points of the plurality of TDCs, and may sequentially control the operation timing points of the plurality of TDCs according to the plurality of TDC control signals (e.g., TDC_CNV1˜TDC_CNV8) received from the control signal generator 240.

By shifting the operation timing points at which TDC codes are generated and repeating the timing points (P1˜P8), transmission of emitted light (EL), the operation of detecting SPAD pulses corresponding to reflected light (RL), and the operation of accumulating the histogramming information (e.g., index of the memory region, an added value, and (calc) of FIG. 7) may be repeatedly performed. At this time, the amount of change in the operation timing of the TDC block 210 may be set more precisely than the time resolution of the TDC block 210.

As described above, since the operation timing points of the plurality of TDCs are different for each detection of the SPAD pulse, measurements may occur in which a code transition time of the TDC data (TDC_OUT) and the start and end of the measurement range (TR) do not coincide with each other. The controller 221 may be activated based on the enable signal (CALC_EN) during the measurement range (TR). Accordingly, the controller 221 may detect not only the measurement range (TR) but also specific information required to strobe TDC data (TDC_OUT) from the TDC block 210, so that the controller 221 may prevent the value of the histogram memory 222 from being updated.

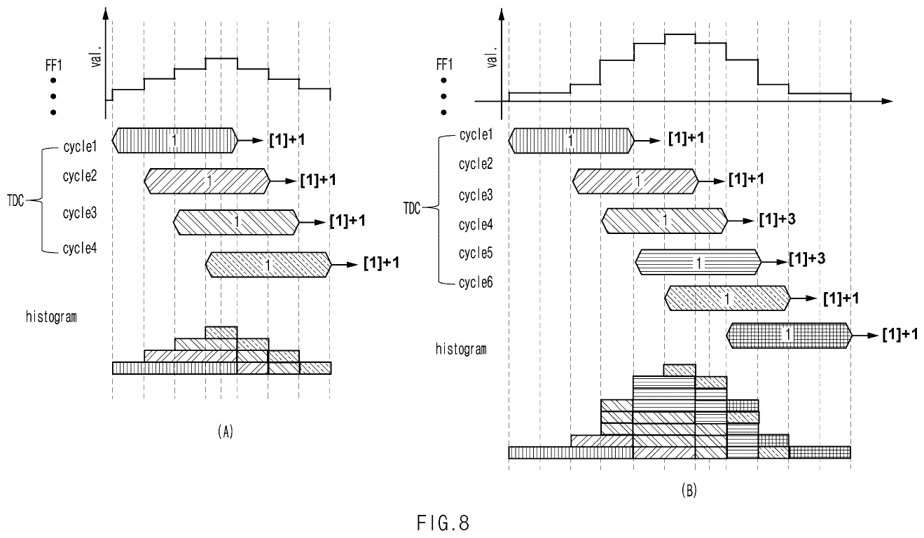

FIG. 8 is a diagram illustrating the histogramming operation for use in the image sensing device shown in FIG. 6.

In the embodiment of FIG. 7 described above, it has been described as an example that the feature function (FF) is 8 (FF1˜FF8) and each feature function is set as a first-order spline function with a different peak time.

However, the embodiment of (A) of FIG. 8 shows that the feature function (FF) illustrated on the vertical axis is formed in a step shape of 4 steps rather than a step shape of 8 steps. In each of 4 steps of the feature function (FF), the operation cycle (cycle1˜cycle4) of the TDC may be controlled differently and the measurement operation may be repeated to generate the histogram as a time average.

In addition, in the embodiment of (B) of FIG. 8, it can be shown that the feature function (FF) illustrated on the vertical axis is a step shape of 5 steps and a time width of each step may be set differently. For example, after the TDC code is input in Cycle 1 (cycle1), the feature function (FF) may maintain the step without change for two sections and then transition to the second step in Cycle 2 (cycle2). In each of the five steps of the feature function (FF), the operation cycles (cycle1˜cycle6) of the TDC may be controlled differently, but the measurement operation may be repeated in a specific step or the measurement operation may not be performed in a specific step. For example, although the update value can be set to ‘1’ in each operation cycle, the update value ‘3’ can be generated by repeating each of the operation cycle 3 and the operation cycle 4 three times.

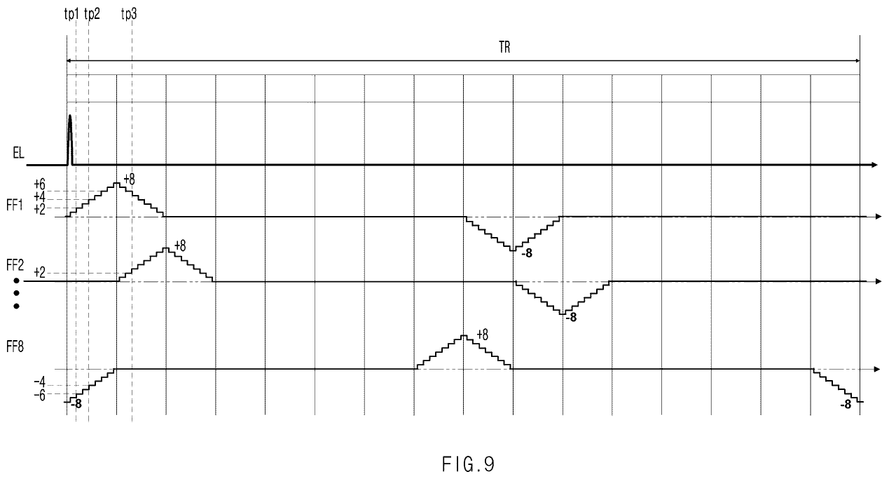

FIG. 9 is a diagram illustrating the histogramming operation for use in the image sensing device shown in FIG. 6.

Referring to FIG. 9, the controller 221 may have a feature function (FF) as a sensitivity function, which may have a positive(+) value or a negative(−) value. That is, the controller 221 may obtain the value of the feature function (FF) having different signs in response to one timebin. If the accumulated value of the photon count values is a positive(+) value, the feature function (FF) may have a positive(+) value, and if the accumulated value of the photon count values is a negative(−) value, the feature function (FF) may have a negative(−) value. Accordingly, information about two memory regions can be determined in one timebin.

For example, if photon detection occurs at the timing point (tp1), the value of the feature function (FF1) may be ‘+2’ and the value of the feature function (FF8) may be ‘−6’. Accordingly, the value of the memory region ‘1’ may be updated by ‘+2’ and the value of the memory region ‘8’ may be updated (decremented) by ‘−6’.

If detection of a photon occurs at the timing point (tp2), the value of feature function (FF1) may become ‘+4’ and the value of the feature function FF8 may become ‘−4’. Accordingly, the value of the memory region ‘1’ may be updated by ‘+4’ and the value of the memory region ‘8’ may be updated by ‘−4’.

In addition, when detection of a photon occurs at the timing point (tp3), the value of the feature function (FF1) may become ‘+6’ and the value of the feature function (FF2) may become ‘+2’. Accordingly, the value of the memory region ‘1’ may be updated by ‘+6’ and the value of the memory region ‘2’ may be updated by ‘+2’.

Generally, when ambient light (also called ‘background light’) is strong, the ambient light is added to the count number, so that the memory width of each bin should be secured.

However, according to the present disclosure, when the ambient light is strong, the expected number of incident photons of the ambient light in a time section of the discrete function having a positive(+) sign is equal to the expected number of incident photons of the ambient light in a time section of the discrete function having a negative(−) sign, so that the average value of the feature function may become zero ‘0’. According to the image sensing device of the present disclosure, even when the ambient light is strong, the memory width need not be increased.

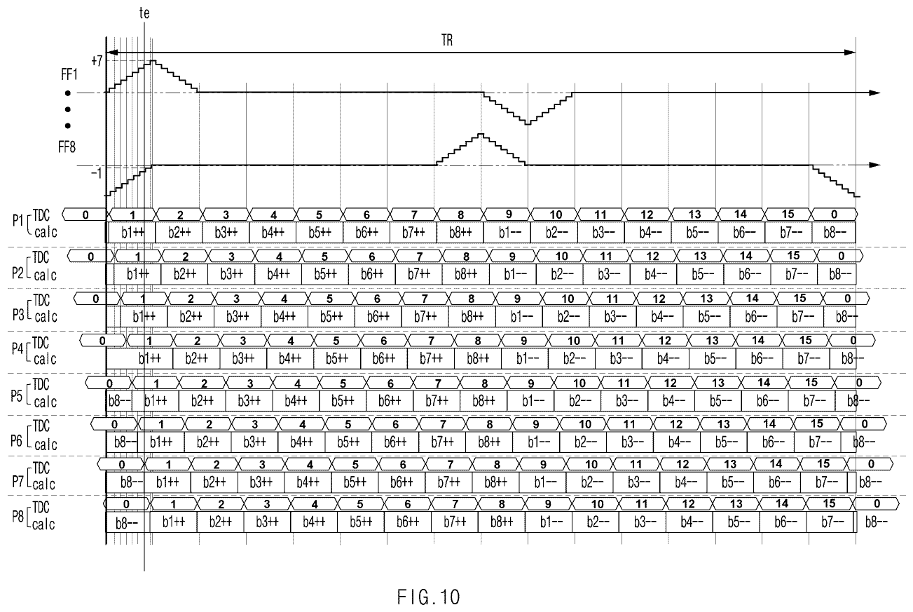

FIG. 10 is a diagram illustrating an histogramming operation for use in the image sensing device shown in FIG. 6 according to another embodiment of the present disclosure.

In the image sensing device 10_1 according to the embodiment of FIG. 10, duplicate descriptions of the same components as those of FIG. 7 will herein be omitted for brevity, and only different components from those of FIG. 7 will be described in detail with reference to FIG. 10.

In the embodiment of FIG. 10, in order to clearly describe the sign of the value (calc) generated by the controller 221, the signs ‘b1++’ and ‘b1−−’ will be used in FIG. 10. Here, ‘b1’ may represent index information of the memory region, ‘++’ may represent an updated value to be added, and ‘−−’ may represent an updated value to be subtracted.

For example, when a photon is incident upon the SPAD element 101 at the timing point (the), then, the added value of the memory region ‘1’ (b1) may be output as ‘+7’. A subtracted value of the memory region ‘8’ (b8) may be output as ‘−1’. As described above, the present disclosure may reduce a bit width of the memory region by outputting positive update values and negative update values in each timebin.

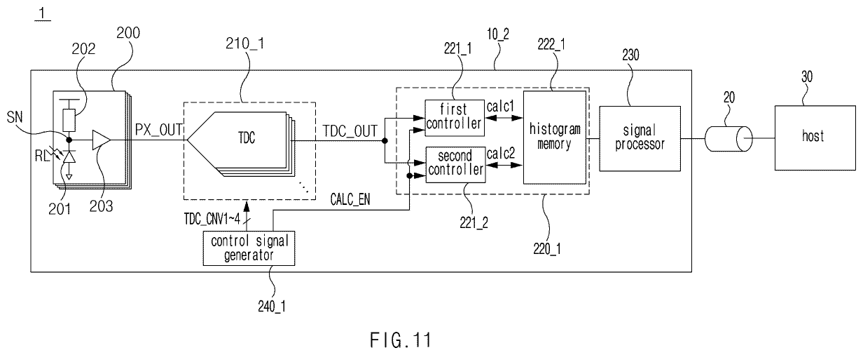

FIG. 11 is a schematic diagram illustrating an image sensing device 10-2 according to another embodiment of the present disclosure.

Referring to FIG. 11, the image sensing device 10_2 may include a pixel 200, a TDC block 210_1, a histogramming circuit 220_1, a signal processor 230, and a control signal generator 240_1. In the image sensing device 10_2, duplicate descriptions of the same components as those of FIG. 6 will herein be omitted for brevity, and only different components from those of FIG. 6 will be described in detail with reference to FIG. 11.

The TDC block 210_1 may include a plurality of TDCs. The operation timing points of the plurality of TDCs may be controlled differently according to a plurality of TDC control signals (TDC_CNV1˜TDC_CNV4) received from the control signal generator 240_1. For example, based on the plurality of TDC control signals (TDC_CNV1˜TDC_CNV4), the plurality of TDCs may be sequentially activated to generate a plurality of digital codes (TDC_OUT0˜ TDC_OUT15). The operation of the TDC block 210_1 will be described in more detail with reference to the attached drawings to be described below.

The histogramming circuit 220_1 may generate a histogram based on TDC data (TDC_OUT). The histogramming circuit 220_1 may include a first controller 221_1, a second controller 221_2, and a histogram memory 222_1.

When there is a response to a SPAD pulse, a strobe signal indicating that not only the TDC code but also the response has occurred may be transferred from the TDC block 210_1 to the first controller 221_1 and the second controller 221_2. This strobe signal may be included in the TDC data (TDC_OUT).

The first controller 221_1 and the second controller 221_2 may be activated based on an enable signal (CALC_EN). For example, the first controller 221_1 and the second controller 221_2 may perform the histogramming operation based on the TDC data (TDC_OUT) when the enable signal (CALC_EN) is at an activation level (e.g., a logic level of 1). The first controller 221_1 and the second controller 221_2 may stop the histogramming operation when the enable signal (CALC_EN) is at a deactivated level (e.g., a logic level of 0).

The first controller 221_1 may generate information about a memory region and an update value (referred to as a first value ‘calc1’) for the corresponding memory region based on the TDC data (TDC_OUT). The second controller 221_2 may generate information about a memory region and an update value (referred to as a second value ‘calc2’) for the corresponding memory region based on the TDC data (TDC_OUT). The first controller 221_1 and the second controller 221_2 may be activated at different timing points based on the enable signal (CALC_EN). That is, the first value (calc1) may be output, and the second value (calc2) may be output after lapse of a certain time from the output time of the first value (calc1).

The first controller 221_1 and the second controller 221_2 may determine a memory region corresponding to the TDC code, and may generate an update value for the corresponding memory region as ‘+1’. The information of the memory region and the updated values (calc1, calc2) generated by the first controller 221_1 and the second controller 221_2 may be stored in the histogram memory 222_1. The values stored in the histogram memory 222_1 may be output to the signal processor 230 in a certain unit (e.g., in frame units).

In addition, the control signal generator 240_1 may generate a plurality of TDC control signals (TDC_CNV1˜TDC_CNV4) for controlling the operation timing points of the plurality of TDCs. The plurality of TDC control signals (TDC_CNV1˜TDC_CNV4) may be activated at different timing points. For example, the plurality of TDC control signals (TDC_CNV1˜TDC_CNV4) may be activated sequentially.

The control signal generator 240_1 may generate an enable signal (CALC_EN) to activate the first controller 221_1 and the second controller 221_2. For example, the control signal generator 240_1 may generate a first enable signal to activate the first controller 221_1 and a second enable signal to activate the second controller 221_2. In this case, the control signal generator 240_1 may activate the first enable signal and then activate the second enable signal after lapse of a certain period of time from the activation time of the first enable signal.

In the embodiment of FIG. 6, only values of only one memory region may be updated when one photon is detected. In contrast, in the embodiment of FIG. 11, two memory regions may be updated for one photon detection operation, so that deterioration of measurement precision can be prevented.

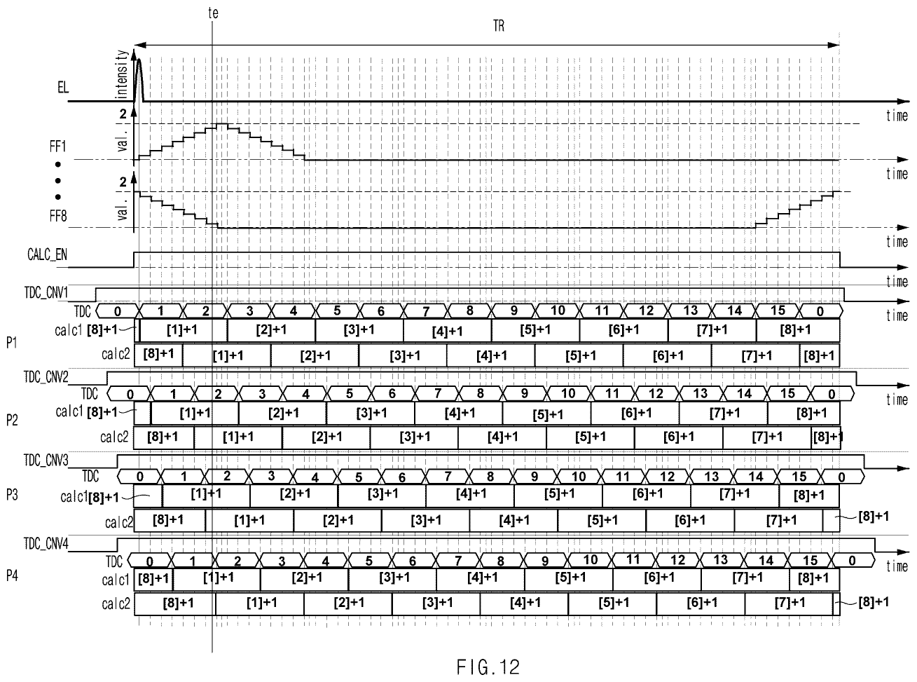

FIG. 12 is a diagram illustrating a histogramming operation for use in the image sensing device shown in FIG. 11.

In the image sensing device 10_2, duplicate descriptions of the same components as those of FIG. 7 will herein be omitted for brevity, and only different components from those of FIG. 7 will be described in detail with reference to FIG. 12.

Referring to FIG. 12, the histogramming circuit 220_1 may control the update operation of two controllers (221_1, 221_2) with one TDC code value. The TDC block 210_1 may generate TDC data (TDC_OUT) at a speed twice that of the embodiment of FIG. 7.

The time resolution of TDC data (TDC_OUT) may be set to 2/8 (i.e., ¼), rather than 1 step (one stage) of the discrete function. That is, 8 steps of the discrete function may correspond to two TDC codes. The TDC block 210_1 may convert the response time of the SPAD pulse into one TDC code with a time resolution corresponding to 4 steps of each discrete function. 16 codes of TDC data (TDC_OUT0˜ TDC_OUT15) may be generated within the measurement range (TR). That is, the TDC block 210_1 may generate 16 TDC codes (0˜15) with a time resolution that divides the measurement time into 16 sections.

Since the embodiment of FIG. 12 can obtain two sets of histogramming information during one photon detection operation, only half of the timing points (P1˜P4) are required compared to the embodiment of FIG. 7. In the embodiment of FIG. 12, switching of four timing points (four phases) P1 to P4 may be performed for each emission of the emitted light (EL) to implement each feature function (FF). For example, the timing point of P1 may be used for the first emission, and the timing point of P2 may be used for the second emission. In this way, the timing point of P4 may be used for the fourth emission in the same manner as described above. Then, the timing point of P1 may be used again for the fifth emission, and then the timing point of P2 may be used for the sixth emission. In this way, the timing points (P1˜P4) may be used in a cyclic manner as described above.

First, at the P1 timing point, before the measurement range (TR) is initiated, the TDC control signal (TDC_CNV1) reaches a logic high level (first level), so that the first TDC is activated and transition of the TDC code may begin. For example, when there was a response to the SPAD pulse at the timing point (the), then, at the P1 timing point, the TDC code when a response to the SPAD pulse is detected may be ‘2’. In this case, the controllers (221_1, 221_2) may output an index ‘1’ of the memory region to be updated and a value ‘+1’ to be added. Then, the value stored in the memory region ‘1’ of the histogram memory 222_1 may be updated by ‘+1’.

Subsequently, at the P2 timing point, the TDC control signal (TDC_CNV2) may be initiated with a time delay of ¼ of the time resolution of the TDC data (TDC_OUT). That is, the TDC control signal (TDC_CNV2) may be activated with a certain time delay compared to the TDC control signal (TDC_CNV1). When the TDC control signal (TDC_CNV2) reaches a logic high level (first level), the second TDC may be activated and transition of the TDC code may begin.

For example, when there was a response to the SPAD pulse at the timing point (the), then, the TDC code when the response to the SPAD pulse is detected at the P2 timing point may be ‘2’. In this case, the controllers (221_1, 221_2) may output the index 1 of the memory region to be updated and the value ‘+1’ to be added. Then, the value stored in the memory region ‘1’ of the histogram memory 222_1 may be updated by ‘+1’. Similarly, the operations of the controllers (221_1, 221_2) as described above may be performed at the P3 timing point.

Thereafter, at the P4 timing point, the TDC control signal (TDC_CNV4) may be initiated with a time delay of ¾ of the time resolution of the TDC data (TDC_OUT) compared to the P1 timing point. That is, the TDC control signal (TDC_CNV4) may be activated with a time delay of a certain time compared to the TDC control signal (TDC_CNV3). When the TDC control signal (TDC_CNV4) reaches a logic high level (first level), the fourth TDC may be activated and transition of the TDC code may begin.

For example, when there was a response to the SPAD pulse at the timing point (the), then, the TDC code when the response to the SPAD pulse is detected at the timing point (P4) may be ‘1’. In this case, the first controller 221_1 may output the index ‘1’ of the memory region to be updated and the value ‘+1’ to be added. Then, the value stored in the memory region ‘1’ of the histogram memory 222_1 may be updated by ‘+1’. On the other hand, the second controller 221_2 may output the index ‘8’ of the memory region to be updated and the value ‘+1’ to be added. Then, the value stored in the memory region ‘8’ of the histogram memory 222_1 may be updated by ‘+1’.

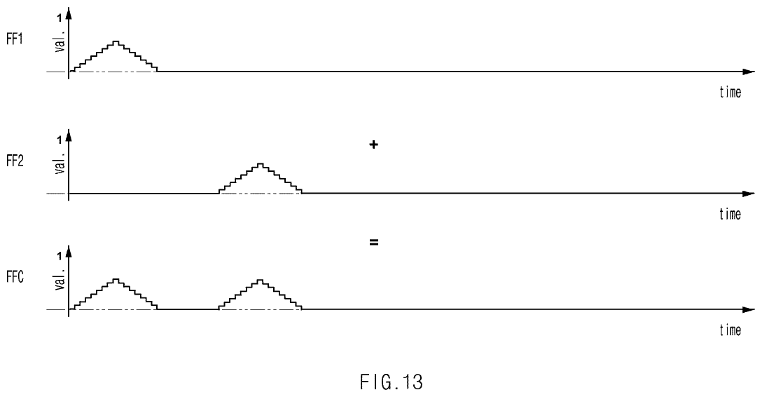

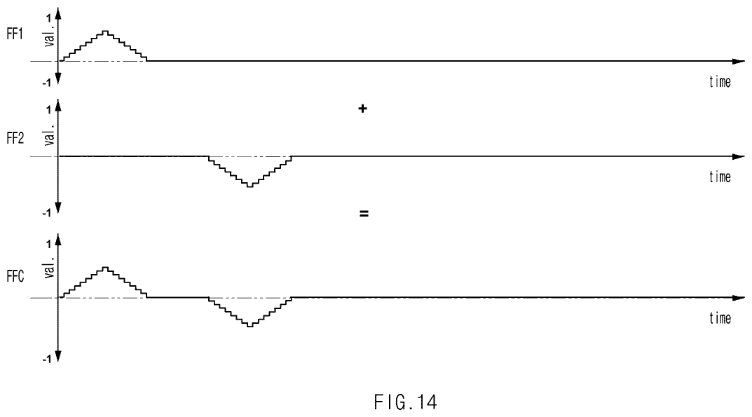

FIGS. 13 and 14 are diagrams illustrating the histogramming operation for use in the image sensing device shown in FIG. 11 according to another embodiment of the present disclosure.

The image sensing device 10_2 according to the embodiment of FIG. 13 may represent an example case where there are two feature functions (FF). The feature function (FF1) and the feature function (FF2) can be combined to generate a combined feature function (FFC) that overlaps at the operating speed of the same TDC. When performing the histogramming operation using the combined feature function (FFC), two or more update values may be required.

In addition, the image sensing device 10_2 according to the embodiment of FIG. 14 may determine a combined feature function (FFC) that overlaps by combining a feature function (FF1) having a positive(+) value and a feature function (FF2) having a negative(−) value. Since the feature function (FF1) having a positive value and the feature function (FF2) having a negative value are combined to set the combined feature function (FFC), the average value of the combined feature function (FFC) may become zero ‘0’. Then, since the number of histogram counts by the ambient light is canceled out, there is no need to increase the memory width even when the ambient light is strong.

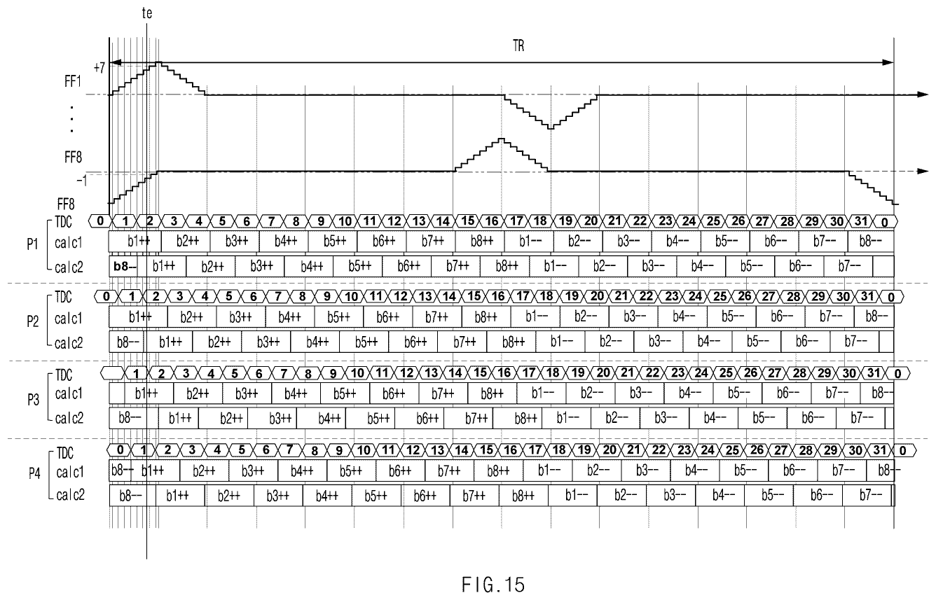

FIG. 15 is a diagram illustrating a histogramming operation according to the embodiment of FIG. 11.

In the image sensing device 10_2 shown in FIG. 15, duplicate descriptions of the same operations as those of FIG. 12 will herein be omitted for brevity, and only different operations from those of FIG. 12 will be described in detail with reference to FIG. 15.

In the embodiment of FIG. 15, in order to clearly describe the signs of the values (calc1, calc2) generated by the first controller 221_1 and the second controller 221_2, the signs ‘b1++’ and ‘b1−−’ will be used in FIG. 15. Here, ‘b1’ may represent index information of the memory region, ‘++’ may represent an updated value to be added, and ‘−−’ may represent an updated value to be subtracted.

For example, when a photon is incident upon the SPAD element 101 at the timing point (the), then, the added value of the memory region ‘1’ (b1) may be output as ‘+7’. A subtracted value of the memory region ‘8’ (b8) may be output as ‘−1’. As described above, the present disclosure may reduce a bit width of the memory region by outputting positive update values and negative update values in each timebin.

Accordingly, the embodiment of FIG. 15 may suppress deterioration of the signal-to-noise ratio (SNR) by updating the values of two memory regions for one photon detection.

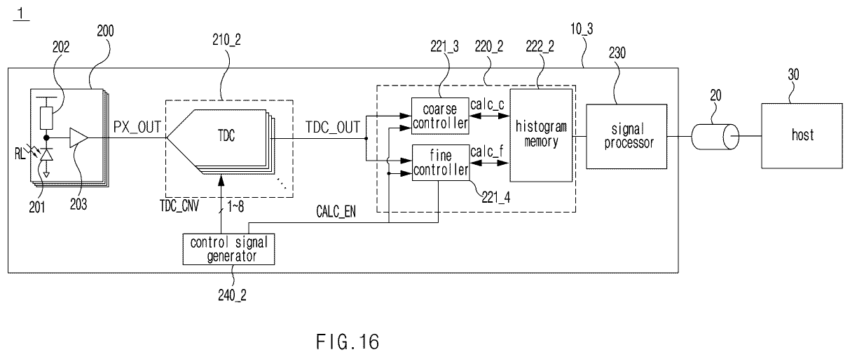

FIG. 16 is a schematic diagram illustrating an image sensing device according to still another embodiment of the present disclosure.

Referring to FIG. 16, the image sensing device 10_3 may include a pixel 200, a TDC block 210_2, a histogramming circuit 220_2, a signal processor 230, and a control signal generator 240_2. In the image sensing device 10_3, duplicate descriptions of the same components as those of FIG. 6 will herein be omitted for brevity, and only different components from those of FIG. 6 will be described in detail with reference to FIG. 16.

The histogramming circuit 220_2 may generate a histogram based on TDC data (TDC_OUT). The histogramming circuit 220_2 may perform the histogramming operation by combining the spline sketch method and the partial histogramming method. The histogramming circuit 220_2 may estimate a peak position based on a histogram obtained by coarse measurement, and may control the operation of fine measurement using the estimated peak position.

The histogram circuit 220_2 may include a coarse controller 221_3, a fine controller 221_4, and a histogram memory 222_2.

The coarse controller 221_3 may generate not only information about a memory region but also an update value (referred to as a third value ‘calc_c’) for the corresponding memory region based on the TDC data (TDC_OUT) when the enable signal (CALC_EN) is activated. For example, the coarse controller 221_3 may determine an index of a memory region corresponding to a TDC code, and may generate an update value for the corresponding memory region as ‘+1’.

The fine controller 221_4 may generate a fine measurement value (referred to as a fourth value ‘calc_f’) in a measurement period (i.e., a zoom-in section TZ to be described later) of a specific TDC code. The fine controller 221_4 may perform measurement at a smaller time interval than the coarse controller 221_3, and may generate fine measurement values due to the influence of noise or pulse width.

The information of the memory region and the updated values (calc_c, calc_f) generated by the coarse controller 221_3 and the fine controller 221_4 may be stored in the histogram memory 222_2. The values stored in the histogram memory 222_2 may be output to the signal processor 230 in a certain unit (e.g., in frame units).

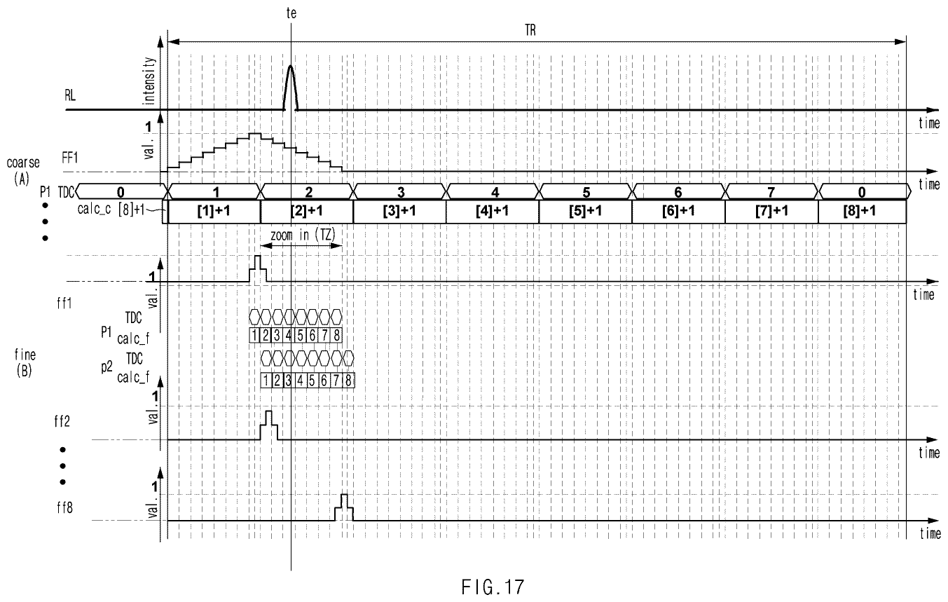

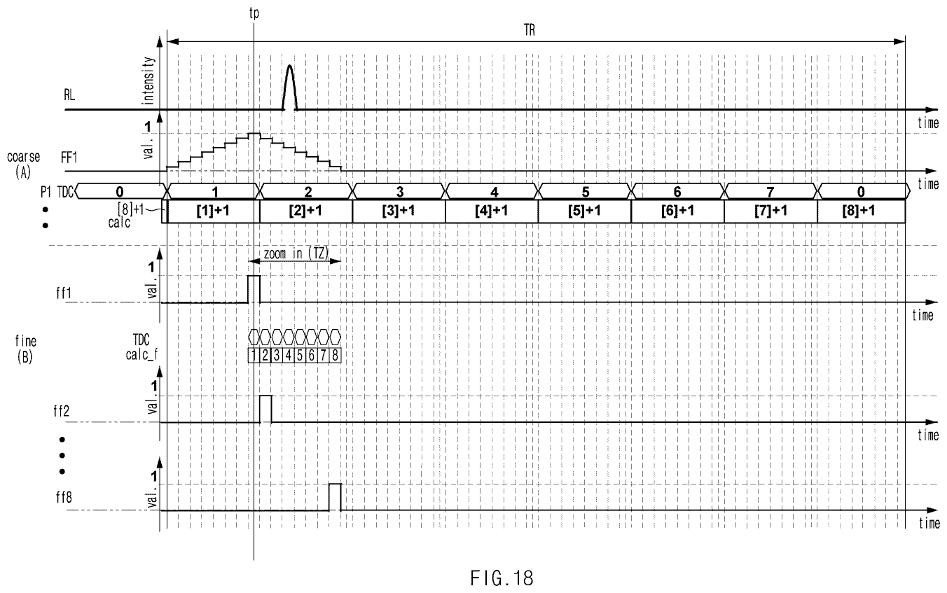

The operation of the histogramming circuit 220_2 having the above-described configuration will be described in more detail with reference to FIGS. 17 and 18 to be described below.

FIG. 17 is a diagram illustrating a histogramming operation for use in the image sensing device shown in FIG. 16.

In the image sensing device 10_3, duplicate descriptions of the same operations as those of FIG. 7 will herein be omitted for brevity, and only different operations from those of FIG. 7 will be described in detail with reference to FIG. 17.

Referring to FIG. 17, the histogramming circuit 220_2 may perform the histogramming operation by combining the feature function (FF) that uses the discrete function of a step shape of 8 steps and the partial histogramming method.

In (A) of FIG. 17 an example case where the coarse measurement is performed by the coarse controller 221_3 is shown. In the coarse measurement of (A) of FIG. 17, the number of steps of the discrete function may be 8, and the number of memory regions may be 8.

For example, when there was a response to the SPAD pulse at the timing point (tₑ), then, the TDC code when the response to the SPAD pulse is detected may be 2. In this case, the coarse controller 221_3 may output the index 2 of the memory region to be updated and the value ‘+1’ to be added. Then, the value stored in the memory region ‘2’ of the histogram memory 222_2 may be updated by ‘+1’. The coarse measurement operation shown in (A) of FIG. 17 is the same as FIG. 7, and as such a detailed description thereof will be omitted.

In (B) of FIG. 17 an example case where fine measurement is performed by the fine controller 221_4 is shown. Each fine feature function (ffi), where ‘i’ is the index of the memory, of the fine measurement may be written in lowercase letters to distinguish the fine feature function (ffi) from each feature function (FFi) of the coarse measurement.

For example, the number of fine feature functions (ff) may be set to 8 (ff1˜ff8) and each fine feature function (ff) may be set to a first-order spline function with a different peak time. The value (val) shown on the vertical axis may represent the feature value of the fine feature function (ff), and may be a value substituted into a discrete function of a step shape of 2 steps.

In the fine measurement of (B) of FIG. 17, the value of the zoom-in section (TZ) indicated by a double-sided arrow can be measured. One fine feature function (ff1) having 2 steps per step of the feature function (FF) can be matched. For example, when the response pulse of the reflected light (RL) is detected at TDC code ‘2’, this range may be set as the zoom-in section (TZ).

The fine controller 221_4 may use two timing points (two phases) (p1, p2) to implement each fine feature function (ff).

Each timing point (p1, p2) of the fine measurement may be written in lowercase letters to distinguish each of the timing points (p1, p2) from each timing point (P1˜P8) of the coarse measurement. For example, the fine controller 221_4 may use the P1 timing point in synchronization with 1 step of the fine feature function (ff1), and may use the P2 timing point in synchronization with 2 steps of the fine feature function (ff1). That is, the P2 timing point may be activated after the P1 timing point is initiated and delayed for a certain period of time.

Eight fine TDC codes may be generated based on the P1 timing point within the zoom-in section (TZ). Eight fine TDC codes may be generated based on the P2 timing point within the zoom-in section (TZ). The fine measurement value (calc_f) generated by the fine controller 221_4 may be transferred to the histogram memory 222_2. The value stored in the memory region ‘2’ of the histogram memory 222_2 may be updated by the fine measurement value (calc_f).

The number of steps of the discrete function used in the fine measurement may be 2, and the number of memory regions may be 8. In this case, the precision required for the coarse measurement may be sufficient to a level where no signal loss occurs due to the fine measurement, rather than the precision of the final measurement. Since the fine measurement has a short time for the ambient light noise to affect each feature function, the fine measurement can realize the same precision as the TCSPC including partial histogramming.

FIG. 18 is a diagram illustrating a histogramming operation for use in the image sensing device shown in FIG. 16.

In the image sensing device 10_2, duplicate descriptions of the same operations as those of FIG. 17 will herein be omitted for brevity, and only different operations from those of FIG. 17 will be described in detail with reference to FIG. 18.

In the embodiment of FIG. 18, a value (val) illustrated on the vertical axis may represent a fine feature function (ff). In contrast to the feature function illustrated as a discrete function formed in a step shape of 2 steps as shown in FIG. 17, in the embodiment of FIG. 18, the feature function may have a one-shot pulse shape. The fine feature function (ff) of the pulse shape may correspond to one step of the feature function (FF).

The fine feature functions (ff1˜ff8) may be sequentially activated in response to each step of the feature functions (FF1˜FF8) within the zoom-in section (TZ). For example, at the timing point (tp) having the highest peak value, the pulse of the first fine feature function (ff1) may be activated in response to the feature function (FF1). Thereafter, the pulse of the fine feature function (ff2) may be activated in response to the feature function (FF2) having the second highest peak value. Similarly, the pulses of the fine feature functions (ff3˜ff8) that respectively match the feature functions (FF3˜FF8) may be sequentially activated in response to the feature functions (FF3˜FF8).

When the fine feature function (ff) is activated, the fine controller 221_4 may output more detailed information (i.e., detailed update value (calc_f) from the TDC code ‘2’) based on the TDC code.

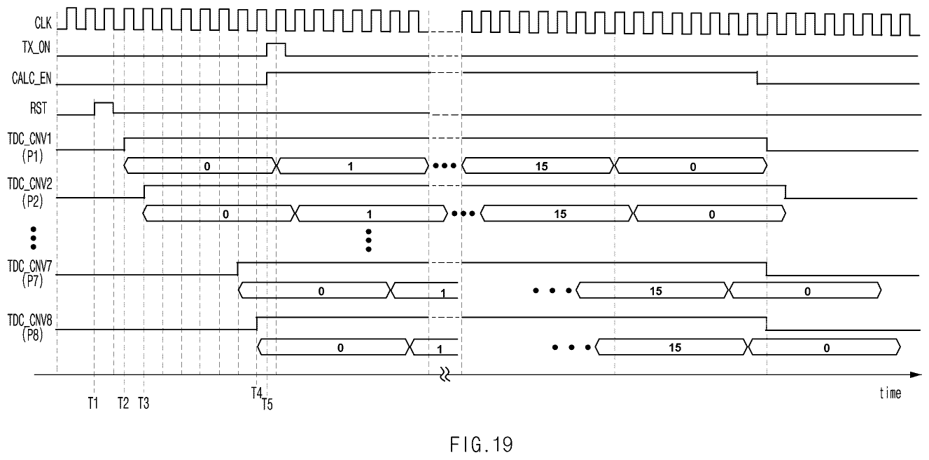

FIG. 19 is a timing diagram illustrating operations of the control signal generator shown in FIG. 6.

The embodiment of FIG. 19 may be equally applied not only to the embodiment of FIG. 6 but also to the embodiments of FIGS. 11 and 16, but embodiments are not limited thereto. For convenience of description and better understanding of the present disclosure, the embodiment of FIG. 19 is applied to the embodiment of FIG. 6.

Referring to FIG. 19, the operation of the control signal generator 240 may be reset based on a reset signal (RST) at the timing point (T1). The reset signal (RST) may be a signal generated by a timing controller (to be described later).

After lapse of a predetermined time from a reset time of the control signal generator 240, the TDC control signal (TDC_CNV1) may be activated at the timing point (T2), so that transition of the TDC code may begin. After lapse of a predetermined time from the timing point (T2), the TDC control signal (TDC_CNV2) may be activated at the timing point (T3), thereby allowing the TDC code to transition. Similarly, after a predetermined time has elapsed after the timing point (T3), the TDC control signals (TDC_CNV3˜TDC_CNV8) are sequentially activated until reaching the timing point (T4), thereby allowing the TDC code to transition.

Afterwards, when a transfer signal (TX_ON) is activated at the timing point (T5), the target object may be irradiated with the emitted light (EL). The transfer signal (TX_ON) may be a signal generated by a timing controller (to be described later). The control signal generator 240 may activate the enable signal (CALC_EN) at the timing point (T5). Then, the histogramming operation of the histogramming circuit 220 may be performed during the time section in which the enable signal (CALC_EN) is activated.

As described above, the image sensing device according to the present disclosure can generate the histogram more precisely by sequentially activating the TDC control signals (TDC_CNV1˜TDC_CNV8) at different timing points (P1˜P8) without fixing the TDC control signals (TDC_CNV1˜TDC_CNV8). The above-described operation may be implemented by applying, for example, a clock (CLK), a DLL (Delay Locked Loop), or a counter having a higher frequency than the time resolution of the TDC to the control signal generator 240.

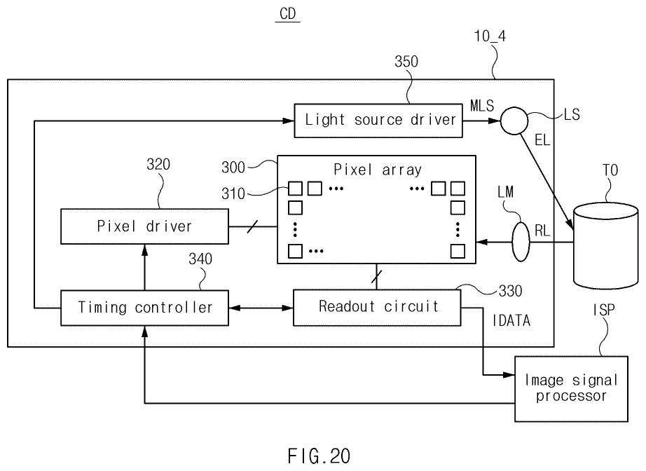

FIG. 20 is a schematic diagram illustrating an imaging device (CD) including the image sensing device according to the embodiments of the present disclosure.

Referring to FIG. 20, the imaging device (CD) may refer to a device, for example, a digital still camera for photographing still images or a digital video camera for photographing moving images. For example, the imaging device (CD) may be implemented as a Digital Single Lens Reflex (DSLR) camera, a mirrorless camera, or a smartphone, and others. The imaging device (CD) may include a device having both a lens and an image pickup element such that the device can capture (or photograph) a target object and can thus create an image of the target object. In some embodiments, the imaging device (CD) may be implemented as a Lidar sensor.

The imaging device (CD) may include an image sensing device 10_4 and an image signal processor (ISP).

The image sensing device 10_4 may be or include a complementary metal oxide semiconductor image sensor (CIS) for converting an optical signal into an electrical signal. The image sensing device 10_4 may measure the distance to a target object using a Time of Flight (TOF) method. In the embodiment of FIG. 20, the image sensing device 10_4 may represent the image sensing devices (10, 10_1, 10_2, 10_3) described above.

The image sensing device 10_4 may include a light source (LS), a lens module (LM), a pixel array 300, a pixel driver 320, a readout circuit 330, a timing controller 340, and a light source driver 350. Referring to FIG. 20, the pixel 310 included in the pixel array 300 may represent the pixel 200. The timing controller 340 may include the control signal generators (240, 240_1, 240_2).

The light source (LS) may emit light to a target object (TO) upon receiving a clock signal (MLS) from the light source driver 350. The light source (LS) may be a laser diode (LD) or a light emitting diode (LED) for emitting light (e.g., infrared (IR) light or visible light) having a specific wavelength band, or may be any one of a Near Infrared Laser (NIR), a point light source, a monochromatic light source combined with a white lamp or a monochromator, and a combination of other laser sources.

For example, the light source (LS) may emit infrared (IR) light having a wavelength of 800 nm to 1000 nm. In some embodiments, the following description will be made based on that the light source (LS) emits infrared light. On the other hand, light emitted from the light source (LS) may be pulse light having a predetermined period, amplitude, and pulse width. Although FIG. 20 shows only one light source (LS) for convenience of description, the embodiments are not limited thereto, and a plurality of light sources (LS) may also be arranged in the vicinity of the lens module (LM).

The lens module (LM) may collect light reflected from the target object (TO), and may allow the collected light to be focused onto pixels 310 of the pixel array 300. For example, the lens module (LM) may include a focusing lens having a surface formed of glass or plastic or another cylindrical optical element having a surface formed of glass or plastic. The lens module (LM) may include a plurality of lenses arranged around an optical axis.

The pixel array 300 may include a plurality of pixels 310 consecutively arranged in a two-dimensional (2D) matrix structure in which pixels 310 are consecutively arranged in a column direction and a row direction perpendicular to the column direction. Each pixel 310 may convert incident light received through the lens module (LM) into an electrical signal corresponding to the amount of incident light, and may thus output a pixel signal using the electrical signal. In this case, the pixel signal may not indicate the color of the target object (TO), and may be a signal indicating the distance to the target object (TO).

Each unit pixel 310 may be an infrared pixel for generating a pixel signal by detecting incident light that includes reflected light (RL) generated when emitted light (EL) irradiated from the light source (LS) is reflected from the target object (TO) and incident upon the unit pixel 310. In some embodiments, the infrared pixel may be a depth pixel for calculating the distance to the target object (TO).

The pixel array 300 in which a plurality of pixels 310 are arranged may detect the distance to the target object (TO) using a direct TOF method. For reference, the direct TOF method may directly measure a round trip time from a first time where pulse light is emitted to the target object (TO) to a second time where pulse light reflected from the target object (TO) is incident, and may thus calculate the distance to the target object (TO) by calculating the round trip time and the speed of light.

The pixel driver 320 may drive the pixel array 300 under the control of the timing controller 340. For example, the pixel driver 320 may generate a control signal capable of selecting and controlling the pixels 310 included in at least one row line among the plurality of row lines of the pixel array 300. In addition, the pixel driver 320 may generate a recharge signal for controlling a recharging operation that implants charges into a sensing node connected to the SPAD element of the pixel 310.

The readout circuit 330 may be disposed at one side of the pixel array 300, may calculate a time delay between a pulse signal output from each pixel 310 and a reference pulse, and may generate digital data corresponding to the time delay. The reference pulse may be a pulse of the clock signal (MLS). The readout circuit 330 may include a digital logic circuit configured to generate digital data by calculating a time delay between a pulse signal of each pixel 310 and a reference pulse, and an output buffer configured to store the generated digital data. The digital logic circuit and the output buffer may hereinafter be collectively referred to as a Time-to-Digital Circuit (TDC) (200, 210, 210_1, 210_2). The readout circuit 330 may transmit the stored digital data to the image signal processor (ISP) under the control of the timing controller 340.

The readout circuit 330 may process the pixel signal (PX_OUT) output from the pixel array 300 under the control of the timing controller 340, and may generate and store depth data for detecting the distance to the target object (TO). Specifically, the readout circuit 330 may calculate a time of flight (TOF) corresponding to the SPAD pulse generated when each pixel 310 senses incident light including reflected light (RL), and may store the time of flight (TOF) corresponding to the SPAD pulse. The readout circuit 330 may transmit the stored TOF to the image signal processor (ISP) under the control of the timing controller 340.

The timing controller 340 may control overall operation of the image sensing device 10_4. That is, the timing controller 340 may generate a clock signal and a timing signal to control operations of the pixel driver 320 and the light source driver 350. According to one embodiment, the timing controller 340 may generate clock and timing signals in response to a request from the image signal processor (ISP) or data received from the readout circuit 330. The timing controller 340 may control the optical power of the emitted light (EL) by controlling the light source driver 350 in response to a control signal received from the readout circuit 330.

In addition, the timing controller 340 may control activation or deactivation of the readout circuit 330, and may control digital data stored in the readout circuit 330 to be simultaneously or sequentially transmitted to the image signal processor (ISP). According to one embodiment, the timing controller 340 may include a logic control circuit, a phase lock loop (PLL) circuit, a timing control circuit, a communication interface circuit, and others.

The light source driver 350 may generate a clock signal (MLS) that can drive the light source (LS) under the control of the timing controller 340. The light source driver 350 may control waveforms (e.g., period, amplitude, pulse width, etc.) of the emitted light (EL) output from the light source (LS).

The image signal processor (ISP) may control the operation of the image sensing device 10_4. In particular, the image signal processor (ISP) may determine an operation mode of the image sensing device 10_4 by analyzing digital data received from the image sensing device 10_4, and may control the image sensing device 10_4 to operate in the determined mode.

The image signal processor (ISP) may perform image signal processing of image data (IDATA) received from the image sensing device 10_4, and may generate processed image data. The image data (IDATA) may include the above-described time of flight (TOF). The image signal processor (ISP) may reduce noise of image data, and may perform various types of image signal processing (e.g. interpolation, lens distortion correction, etc.) for image-quality improvement of the image data.

The image signal processor (ISP) may transmit the processed image data to a host device (not shown). The host device (not shown) may be a processor (e.g. an application processor) for processing the ISP image data received from the image signal processor (ISP), a memory (e.g. a non-volatile memory) for storing the ISP image data, or a display device (e.g. a liquid crystal display (LCD)) for visually displaying the ISP image data.

As is apparent from the above description, the image sensing device based on TOF technology according to the embodiments of the present disclosure can reduce a memory capacity required for system operations while improving an operating speed thereof.

The embodiments of the present disclosure may provide a variety of advantageous effects capable of being directly or indirectly recognized.

Although a number of illustrative embodiments have been described, it should be understood that modifications and enhancements to the disclosed embodiments and other embodiments can be devised based on what is described and/or illustrated in the present disclosure. Furthermore, the embodiments may be combined to form additional embodiments.

What is claimed is:

1. An image sensing device comprising:
a pixel configured to generate a pulse signal based on a photon reflected from a target object;
a plurality of time-to-digital converters (TDCs) configured to generate digital codes corresponding to a time delay between the pulse signal and a reference pulse; and
a histogramming circuit configured to generate index information of a memory region and an update value of the memory region based on the digital codes,
wherein the plurality of TDCs have different activation timing points.

2. The image sensing device according to claim 1, wherein the pixel includes:
a single photon avalanche diode (SPAD) element configured to generate a voltage pulse through a sensing node;
a quenching circuit configured to control a reverse bias voltage applied to the SPAD element to perform a quenching operation; and
a buffer configured to sample the voltage pulse generated through the sensing node and convert the sampled voltage pulse into the pulse signal.

3. The image sensing device according to claim 1, wherein the histogramming circuit is configured to:
overlap a value of a timebin corresponding to a time at which the photon is detected in a time stamp section with a value of an adjacent timebin; and
generate the index information of the memory region and the update value of the memory region based on the digital codes when the pulse signal responds.

4. The image sensing device according to claim 1, wherein the histogramming circuit includes:
a controller configured to generate the update value of the memory region based on a feature function in a time section obtained by dividing a time stamp section by a number of memory regions; and
a histogram memory configured to update a value stored in the memory region by the update value of the memory region.

5. The image sensing device according to claim 4, wherein the feature function is a function that sketches a sine-shaped waveform corresponding to an order of a spline function in the time stamp section.

6. The image sensing device according to claim 4, wherein the controller is configured to:
discretize the feature function with respect to the time stamp value and a number of detection counts of the photon to output the discretized feature function in a step shape in which respective steps have different peak values; and
determine the update value of the memory region corresponding to each step formed in the step shape.

7. The image sensing device according to claim 6, wherein:
the feature function has a form that sequentially increases and then decreases within a plurality of measurement periods; and
the update value of the memory region is set to a positive value corresponding to each step of the feature function.

8. The image sensing device according to claim 6, wherein:
the feature function has a form that sequentially decreases and then increases within a plurality of time sections; and
the update value of the memory region is set to a negative value corresponding to each step of the feature function.

9. The image sensing device according to claim 6, wherein the plurality of TDCs are configured to perform conversion of the digital codes so that a plurality of steps of the feature function corresponds to one digital code.

10. The image sensing device according to claim 1, wherein the histogramming circuit includes:
a first controller configured to generate information about a first memory region and a first update value of the first memory region based on the digital codes;
a second controller configured to generate information about a second memory region and a second update value of the second memory region based on the digital codes; and
a histogram memory configured to update a value stored in the first memory region by the first update value of the first memory region and update a value stored in the second memory region by the second update value of the second memory region.

11. The image sensing device according to claim 10, wherein the first controller and the second controller are activated at different timing points.

12. The image sensing device according to claim 1, wherein the histogramming circuit includes:
a coarse controller configured to generate, during a measurement period, the index information of the memory region and the update value of the memory region based on the digital codes;
a fine controller configured to generate a fine measurement value for the memory region in a zoom-in section corresponding to a specific digital code in which the photon is detected, among the digital codes; and
a histogram memory configured to update a value stored in the memory region in response to output signals of the coarse controller and the fine controller.

13. The image sensing device according to claim 12, wherein the coarse controller is configured to:
discretize a feature function with respect to a time stamp value and a number of detection counts of the photon to output the discretized feature function in a step shape in which each step has a different peak value; and
determine the update value of the memory region corresponding to each step formed in the step shape.

14. The image sensing device according to claim 13, wherein the fine controller is configured to:
generate a plurality of fine feature functions corresponding to each step of the feature function in the zoom-in section,
wherein the plurality of fine feature functions are activated at different timing points.

15. The image sensing device according to claim 14, wherein each of the plurality of fine feature functions is formed in a step shape with a different peak value obtained when each step of the feature function is discretized.

16. The image sensing device according to claim 14, wherein each of the plurality of fine feature functions has a one-shot pulse shape corresponding to each step of the feature function.

17. The image sensing device according to claim 1, further comprising:
a control signal generator configured to sequentially activate a plurality of TDC control signals for controlling the plurality of TDCs after a reset operation, and generate an enable signal for activating the histogramming circuit when emitted light is irradiated on the target object.

18. An image sensing device comprising:
a pixel configured to generate a pulse signal based on a photon reflected from a target object;
a time-to-digital converter (TDC) block configured to generate digital codes corresponding to a time delay between the pulse signal and a reference pulse; and
a histogramming circuit configured to generate a first feature function and a second feature function, each of which has a waveform corresponding to an order of a spline function within a time stamp section in which the photon responds, and generate information of a memory region and an update value of the memory region based on the first feature function and the second feature function,
wherein each of the first feature function and the second feature function is discretized with respect to a time stamp value and a number of detection counts of the photon, and has a step shape in which each step has a different peak value.

19. The image sensing device according to claim 18, wherein the TDC block includes:
a first TDC configured to generate a plurality of first digital codes based on a first TDC control signal at a first timing point; and
a second TDC configured to generate a plurality of second digital codes based on a second TDC control signal at a second timing point following the first timing point.

20. The image sensing device according to claim 19, wherein the first feature function and the second feature function are configured so that update values of at least two or more memory regions are generated when the pulse signal responds after overlapping a timebin corresponding to a time at which the photon is detected.
